(19) United States
(12) Patent Application Publication
(10) Pub. No.: US 2006/0169919 A1
(43) Pub. Date: Aug. 3, 2006

(54) Analytical method using photolysis

(75) Inventors: Hyo-bong Hong, Osan-si (KR); In-gee Kim, Daejeon-si (KR)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: SAMSUNG ELECTRONICS CO., LTD., Suwon-si (KR)

(21) Appl. No.: 11/328,261

(22) Filed: Jan. 10, 2006

(30) Foreign Application Priority Data
Jan. 20, 2005 (KR) 10-2005-0005536

(51) Int. Cl. G01N 21/64

(52) U.S. Cl. 250/461.1

(57) ABSTRACT

An analytical method is provided including: dissolving a sample in a solvent; radiating UV light onto the dissolved sample to separate an ion from the sample; and detecting the kind and concentration of the separated ion using an ion selective electrode. A qualitative analysis and quantitative analysis of a sample can be quickly completed without a pre-treatment or expensive analyzing equipment by measuring the concentration of an ion, which is generated by photolysis while using potentiometry. Therefore, a large quantity of samples can be quickly analyzed at low cost. Due to these advantages, the analytical method can be effectively used under varied analysis conditions.

### CROSS-REFERENCE TO RELATED PATENT APPLICATIONS

This application claims the benefit of Korean Patent Application No. 10-2005-0005536, filed on Jan. 20, 2005, in the Korean Intellectual Property Office, the disclosure of which is incorporated herein in its entirety by reference.

### BACKGROUND OF THE DISCLOSURE

1. Field of the Disclosure

The present disclosure relates to an analytical method using photolysis, and more particularly, to an analytical method in which photolysis is performed using ultra violet (UV) light to generate an ion and the concentration of the ion is measured.

2. Description of the Related Art

In response to increasing environmental pollution, many countries have restricted the use of harmful materials, and these restrictions directly affect business activities.

The European Committee adopted Waste Electrical and Electronic Equipment (WEEE) and Restriction of the use of certain Hazardous Substances (RoHS) in electrical and electronic equipment in March 2002. RoHS will come into effect on Jul. 1, 2006.

WEEE contains regulations on the recycling of discarded electric/electronic products, and RoHS contains regulations inhibiting the use of specific materials that are harmful to the environment, such as the human body or the like. According to RoHS, electric/electronic products which are available in Europe and include banned materials including four heavy metals (Pb, Hg, Cd, 6-valent Cr), and two organic materials (PBB, PBDF) are restricted.

When RoHS comes into effect, the banned materials must not be contained in electric/electronic products exported to Europe and further the absence of the banned materials should be guaranteed. Therefore, a quick and cheap analytical method for detecting the banned materials in mass-produced electric/electronic products must be developed.

Methods of analyzing unknown materials have been developed in the field of analytical chemistry, a branch of chemistry, and many analytical devices have already been developed. However, most of these analytical devices are expensive and require a great amount of time to perform analysis, and thus are not useful for quick and cheap analysis of many products.

Conventional methods of analyzing a metal and an organic material will be described.

XRF (X-ray fluorescent analysis) is an analytical method using fluorescence generated when an X-ray is radiated onto a sample. XRF is advantageous because the sample irradiated with the X-ray is not harmed. However, XRF is used to analyze a surface and the analysis capacity is limited to a few hundred pm in depth from the surface such that the analysis results are not sufficient to determine the presence of an element in a specific sample. In addition, when a sample is composed of many layers, only the uppermost layer of the sample can be analyzed. Furthermore, it is impossible to obtain quantitative data form a sample unless the sample is composed of the same material as a reference (i.e. the other sample) and is homogenous.

Ion chromatography (IC) is performed by passing a sample solution through a column including an ion exchange resin. IC has excellent resolving power and can be used to determine the presence of an element with a concentration less than 1 ppb. However, in order to analyze an ion in an electric product, the electric product must be pulverized, broken using a strong acid or salt, and then refined before analyzing. That is, IC requires a relatively long period of time for a pre-treatment and is very expensive.

ICP-AES or MS (Induced Coupling Plasma-atom Emission Spectroscopy or Mass Spectroscopy) can be used to measure the concentration of an element with a resolution of less than 1 ppm and a quantitative analysis can be performed. However, ICP-AES or MS requires the same pre-treatment as IC, and ICP is also expensive.

Accordingly, in order to detect polybrominated diphenyl ether (PBDE), one of the banned compounds that is used as a flame retardant in a polymer material, very expensive experimental equipment and an expensive reagent must be used and thus the analysis of all electric/electronic products is expensive and requires a long time.

Therefore, a method that can be used to quickly analyze many samples at low cost, but does not require a complex pretreatment, expensive equipment, or a reference needs to be developed.

### SUMMARY OF THE DISCLOSURE

The present invention may provide an analytical method using photolysis that is performed using ultra violet (UV) light.

According to an aspect of the present invention, there may be provided an analytical method including: dissolving a sample in a solvent; radiating ultra violet (UV) light onto the dissolved sample to separate an ion from the sample; and identifying the kind and concentration of the separated ion using an ion selective electrode.

The solvent may be basic.

The solvent may further comprises an electron donor compound.

The electron donor compound may include at least one of an alcohol and an amine.

The solvent may include at least a compound selected from the group consisting of toluene, tetrahydrofurane, chloroform, and acetone.

The kind and concentration of the separated ion may be measured in-situ.

The sample may include a halogen atom.

The sample may include at least a compound selected from the group consisting of poly brominated biphenyl (PBB), poly brominated diphenyl ether (PBDE), tetrabrominated bis phenol (TBBPA), and hexa brominated cyclo dodecane (HBCD), and printed circuit boards (PCBs).

The separated ion may include at least an ion selected from the group consisting of F⁻, Cl⁻, Br⁻ and I⁻.

The wavelength of the UV light may be in the range of 200 to 300 pm.

### BRIEF DESCRIPTION OF THE DRAWINGS

The above and other features and advantages of the present invention are described in detailed exemplary embodiments thereof with reference to the attached drawings in which:

FIG. 1 is a schematic view illustrating an analytical method according to an embodiment of the present invention;

FIG. 2 is a graph of the time variation in a voltage when an ion is separated from decabrominated diphenyl measured using an ion selective electrode; and

FIG. 3 is a graph of voltages of ions separated from standard sample measured using the ion selective electrode.

### DETAILED DESCRIPTION OF EXEMPLARY EMBODIMENTS

Hereinafter, exemplary embodiments of the present invention are described in detail.

In an analytical method according to an embodiment of the present invention,

an ion generated by photolysis using ultra violet (UV) light is analyzed using potentiometry. As a result, more samples can be quickly analyzed at lower costs than in a conventional analytical method requiring a pre-treatment of a sample, X-ray radiation, use of disposable components, or the like. That is, according to the analytical method, a small amount of a compound contained in a sample can be readily analyzed at a lower cost using photolysis and an electrochemical principle when compared with a conventional method.

First, a halogenated compound or the like contained in a polymer sample is separated from the polymer sample by dissolving the polymer sample in, for example, a solvent. The compound to be analyzed is not chemically bonded to the polymer, but mixed with and intercalated in the polymer. That is, the compound is physically bonded to the polymer. Accordingly, when the polymer sample is dissolved in, for example, a solvent, the compound is separated from the polymer and exists in the form of molecules in the solvent.

Next, photolysis is performed by radiating UV light onto the dissolved sample. In general, the bonding between a carbon atom and a halogen atom exhibits polarity because bonding electrons are delocalized due to a difference in electronegativity. The bonding is strong and is thermodynamically stable, and thus has a relatively strong resistance to heat or the like. However, the bonding is weak with respect to a reaction using the polarity of the bonding so that the bonding can be easily substituted by a nucleophile or the like and easily broken by UV light. Since the bonding energy of the carbon-halogen bonding is in the energy range of UV light, an electron can be excited by radiating UV light onto the dissolved sample with a proper wavelength or frequency and thus the compound having the carbon-halogen bonding can be broken into radicals or ions.

The above process will be described in detail, but the following exemplary description is not intended to limit the scope of the present invention.

When the halogenated compound absorbs UV light, the compound transits to an excited state (RX*), as indicated by Reaction Scheme 1.

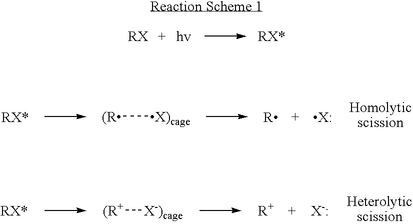

Referring to Reaction Scheme 1, in the excited state, the halogen and the other molecule are separated by a predetermined distance (R—X), that is, RX* is in a Rydberg state. At this time, when a polar solvent, such as water, is used, heterolytic scission often occurs through electron transfer from an ion or the like existing in the solvent. However, when a nonpolar solvent, such as an organic solvent, is used, RX* in the Rydberg state is separated into neutral radicals through homolytic scission. However, when a functional group that can supply electrons to the radical or receive electrons from the radical do not exist in the vicinity of the radical or if the amount of the functional group existing is too small, the separated radicals are recombined and return to their original state. Accordingly, the amount of an ion generated by radiation of UV light is decreased, and thus, the quantum yield is decreased. Since such a low quantum yield indicates a low ionic concentration, a method of increasing the ionic concentration is required, which will be described in detail hereinafter.

The kind and concentration of the separated ion are detected using an ion selective electrode. When an ion is separated in a solution, the ionic concentration of the solution increases. As a result, conductivity is increased and the concentration of a specific ion is changed. The concentration of the specific ion generated in the solution can be measured using various methods, for example, potentiometry. When the change of the concentration of a sample is slow, it can be assumed that the concentration of the ion is in its equilibrium state. Thus, potentiometry is proper. Potentiometry is based on the Nernst equation, which represents the chemical potential caused by a difference in concentrations of an ion existing in two solutions separated by a semipermeable membrane. In other words, the concentration of an unknown solution can be obtained using a voltage difference between a standard solution having a predetermined concentration, and the unknown solution. As an example, an analysis apparatus utilizing potentiometry may be an ion selective electrode. When a selected ion is a hydrogen ion, it is called a pH meter, but when other ions are used, it is called an ion selective electrode. However, other ions besides the selected ion may interfere with the ion selective electrode, and thus, a preferred ion selective electrode must comply with the equation 1

$$E = cont . \pm β \frac{0.05916}{{n}_{X}} log [ {A}_{X} + {\sum }_{Y} ( {k}_{X , Y} {A}_{Y}^{{n}_{X} / {n}_{Y}} ) ] \qquad ( 1 )$$

where cont. is a constant, [[βis]] β is 1 when an anion is used, n_{X} and n_{Y} are the quantities of ions, k_{X,Y} is a selectivity coefficient, A_{X} is the activity of a to-be-measured ion, and A_{Y} is the activity of an interference ion.

Ideally, when the selectivity coefficient is very small, for example, when k<<1, the interference ion does not interfere and the second term in the log term can be removed. In this instance, equation 1 becomes the Nernst equation for a single ion. The ion selective electrode may be composed of glass, inorganic salt crystal, or the like, and provides many advantages. For example, a wide range of linear response, non destruction, no contamination, quick response, no interference due to color, and turbidity, or the like can be obtained.

The above analysis method takes at most approximately one hour to be completed and can be used for qualitative analysis that is used to identify the presence of a specific ion and quantitative analysis that is used to precisely measure the ionic concentration.

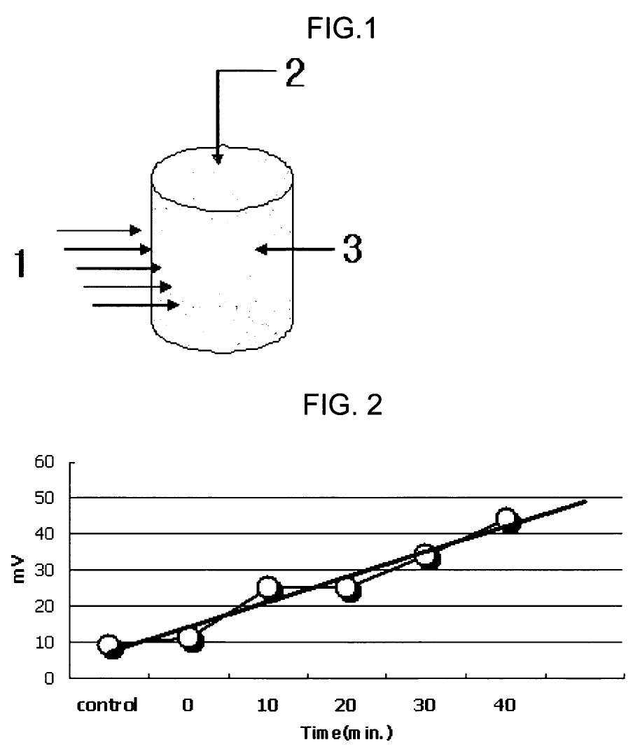

FIG. 1 is a schematic view illustrating an analytical method according to an embodiment of the present invention. Referring to FIG. 1, an ion selective electrode 2 is inserted into a container 3 in which a sample is dissolved in a solvent, and then UV light 1 is radiated onto the resultant contents. When UV light 1 is radiated, an ion is separated from the sample and the concentration of the separated ion is measured using the ion selective electrode 2.

In the present embodiment, the solvent may be basic because, although a polymer sample is typically dissolved in an organic solvent, when the polymer sample has a functional group enabling a reaction with a base, the decomposition of the polymer, and thus the separation of a to-be-measured compound can be facilitated. Salts can sometimes be directly dissolved in the solvent, but it is typically difficult for salt to be dissolved in a non-polar solvent. Therefore, a basic aqueous solution can be manufactured and then mixed and saturated with a non-polar solvent.

The pH of the basic solvent may be 10.0 or greater, preferably, 11.5 or greater. When the pH of the basic solvent is less than 8.0, little reaction between the base and the polymer solvent occurs because the concentration of the base is too small, and thus the decomposition of the polymer is not facilitated. A material used to make the solvent basic may be NaOH, KOH, or the like, but is not limited thereto.

In addition, the solvent may further include an electron donor. An electron donor attacks the carbon of a carbon-halogen bond and supplies an electron for easy separation of a halogen ion. The electron donor may be an anion or be neutral. As illustrated in Reaction Scheme 1, if the sample in a non-polar solvent is excited by UV light and the halogen has weak bonding with the other molecule and is separated at a predetermined distance from the other material, halogen is recombined with the other molecule and thus a quantum yield is decreased. However, when substitute attacks the weak bond between the halogen and the other molecule, the halogen can be easily and completely separated from the other molecule. The electron donor may be a compound enabling nuleophilic substitution, such as alcohol, amine, or the like. For example, the electron donor compound may be methanol, ethanol, methyl amine, or the like.

Any solvent that can dissolve the polymer can be used in the present embodiment. The solvent may be benzene, toluene, dimethylformamide (DMF), tetrahydrofurane (THF), chloroform, acetonitrile, or the like.

In addition, the kind and concentration of the separated ion may be measured in situ. That is, the kind and concentration of the ion which is separated by ultra violet (UV) light may be measured on a real time basis when the ion selective electrode is placed in the solvent. This in-situ measurement results in a decrease in the analysis time and an increase in the reliability of the analysis results.

Any sample that includes a halogen atom and is broken by UV light can be measured in the analytical method. The to-be-measured sample may be poly brominated biphenyl (PBB), poly brominated diphenyl ether (PBDE), tetrabrominated bis phenol (TBBPA), hexa brominated cyclo dodecane (HBCD), printed circuit boards (PCBs), or the like. An ion that is separated by UV light may be F⁻, Cl⁻, Br⁻, I⁻, or the like.

The UV light that is used to separate the ion in the above analytical method may have a wavelength of 100 to 400 nm, but the wavelength of the UV light is not limited thereto. The wavelength of the UV light may be in the range of 200 to 300 nm, which corresponds to the bond energy of carbon-halogen.

The UV light may be radiated by a common UV lamp, but any device that can radiate UV light having a wavelength of 100 to 400 nm and is commonly used in the art can be used in the present embodiment.

Hereinafter, the present invention will be described in detail with reference to the following Examples. These Examples are provided to convey the concept of the invention to those skilled in the art and should not be construed as limiting the scope of the present invention.

### EXAMPLE 1

100 ml of 2M NaOH aqueous solution and 100 ml of toluene were mixed in a 250 ml separatory funnel and the resultant mixture was shaken several times. The mixture was left to sit until the mixture was separated into a water layer and a toluene layer. Then, the water was removed so that only the toluene solution layer saturated with water and NaOH was left. Then, 0.5 ml of methanol was added to 100 ml of the saturated toluene.

In order to measure the concentration of an ion separated through the radiation of UV light produced by a 254 nm UV lamp (Spectroline, ENF-240C), a bromide ion selective electrode (PGC) was immersed in the resulting solvent contained in a beaker and was initialized.

0.01 g of decabrominated diphenyl ether was added to the resulting solvent and then stirred using a stirring bar while the electrical potential difference occurring at an ion selective electrode was measured every 10 minutes.

The measured potential is illustrated in FIG. 2. Referring to FIG. 2, when the concentration of a Br⁻ion increased over time, the voltage increased. ‘Control’ illustrated in FIG. 2 indicates an electrical potential when the sample is not added. The initial potential can be controlled by initializing the ion selection.

### EXAMPLE 2

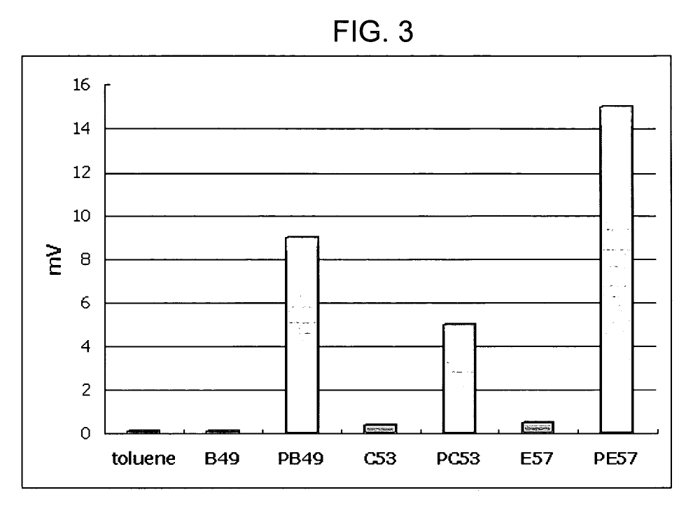

An experiment was performed in the same manner as in Example 1 except that various standard samples (manufactured for GC/MS analysis at BAM, a German national standard Laboratory) were used as a sample instead of decabrominated diphenyl ether and the electrical potentials were measured after 40 minutes. The results are shown in FIG. 3. The concentrations of Br⁻ ions contained in each of the standard samples were obtained using the results.

In an analytical method according to the present invention, a qualitative analysis and quantitative analysis of a sample can be quickly completed without a pre-treatment or expensive analyzing equipment by measuring the concentration of an ion, which is generated by photolysis, using potentiometry. Therefore, a larger quantity of samples can be quickly analyzed at low costs. Due to these advantages, the analytical method according to the present invention can be effectively used in varied analysis conditions.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An analytical method comprising:
dissolving a sample in a solvent;
radiating ultraviolet (UV) light onto the dissolved sample to separate an ion from the sample; and
detecting the kind and concentration of the separated ion using an ion selective electrode.

2. The analytical method of claim 1, wherein the solvent is basic.

3. The analytical method of claim 1, wherein the solvent further comprises an electron donor compound.

4. The analytical method of claim 3, wherein the electron donor compound comprises at least one of an alcohol and an amine.

5. The analytical method of claim 1, wherein the solvent comprises at least a compound selected from the group consisting of toluene, tetrahydrofurane, chloroform, and acetone.

6. The analytical method of claim 1, wherein the kind and concentration of the separated ion are measured in-situ.

7. The analytical method of claim 1, wherein the kind and concentration of the separated ion are measured in-situ.

8. The analytical method of claim 7, wherein the sample comprises at least a compound selected from the group consisting of poly brominated biphenyl (PBB), poly brominated diphenyl ether (PBDE), tetrabrominated bis phenol (TBBPA), and hexa brominated cyclo dodecane (HBCD), and printed circuit boards (PCBs).

9. The analytical method of claim 1, wherein the separated ion comprises at least an ion selected from the group consisting of F⁻, Cl⁻, Br⁻ and I⁻.

10. The analytical method of claim 1, wherein the wavelength of the UV light is in the range of 200 to 300 nm.
